(19) United States
(12) Patent Application Publication
(10) Pub. No.: US 2025/0263340 A1
(43) Pub. Date: Aug. 21, 2025

(54) PHASE-CHANGE HEAT-STORAGE FOAMED CONCRETE AND PREPARATION METHOD AND USE THEREOF

(71) Applicant: Hebei University of Technology, Tianjin (CN)

(72) Inventors: Boxiong SHEN, Tianjin (CN); Qiwei YANG, Tianjin (CN); Zhibin HAN, Tianjin (CN)

(21) Appl. No.: 18/956,599

(22) Filed: Nov. 22, 2024

(30) Foreign Application Priority Data
Feb. 21, 2024 (CN) 202410192575.1

(51) Int. Cl. C04B 20/10; C04B 18/08; C04B 20/02; C04B 24/04; C04B 24/26; C04B 24/36; C04B 28/02; C04B 38/02; C04B 103/00; C04B 103/30; C04B 103/48; C09K 5/06

(52) U.S. Cl. CPC C04B 20/1044; C04B 18/08; C04B 20/023; C04B 24/04; C04B 24/2641; C04B 24/36; C04B 28/02; C04B 38/02; C09K 5/063; C04B 2103/0071; C04B 2103/302; C04B 2103/48; C04B 2201/30

(57) ABSTRACT

A phase-change heat-storage foamed concrete, and a preparation method and use thereof are provided. The phase-change heat-storage foamed concrete provided by the present disclosure is prepared from raw materials including, in percentages by mass: 50-70% of a cement, 2-20% of a supported phase-change material, 15-35% of water, 0.1-0.5% of a water-reducing agent, 0.5-1.5% of a foam stabilizing agent, 0.5-2% of an aqueous hydrogen peroxide solution, and 0.1-0.4% of a hydrogen peroxide decomposition catalyst. The supported phase-change material includes an acid-modified fly ash and a paraffin supported on a surface and in a pore structure of the acid-modified fly ash, and the aqueous hydrogen peroxide solution has a mass percentage concentration of 25-30%.

### CROSS REFERENCE TO RELATED APPLICATION

This patent application claims the benefit and priority of Chinese Patent Application No. 202410192575.1 filed with the China National Intellectual Property Administration on Feb. 21, 2024, the disclosure of which is incorporated by reference herein in its entirety as part of the present application.

### TECHNICAL FIELD

The present disclosure belongs to the technical field of concrete, and particularly relates to a phase-change heat-storage foamed concrete and a preparation method and use thereof.

### BACKGROUND

In recent years, with development of global economy and gradual improvement of scientific and technological strength, overall consumption of social energy continuously increases, which is closely related to energy consumption of infrastructure buildings. In order to reduce the energy consumption for operation of buildings, it is particularly important to develop a new type of heat-insulating building wall to reduce a frequency of use of indoor thermostats such as air-conditioners. Phase-change materials could absorb or emit a large amount of heat during a phase change, so such property may be fully utilized, and the phase-change material may be mixed into a building material to greatly improve indoor temperature conditions of the buildings and greatly reduce a fluctuation of indoor temperature. Thereby, energy consumption of an air-conditioning system could be reduced, and the energy efficiency of the buildings could be improved.

Chinese patent CN 104212416A discloses a method for preparing a paraffin microcapsule phase-change material modified by graphene oxide, where various oxygen-containing groups on a surface of the graphene oxide react with a polymer to improve thermal stability and thermal conductivity of the paraffin microcapsule phase-change material and prolong service life. Chinese patent CN 115043629A discloses a phase-change heat-storage foamed concrete and a preparation method thereof, and a method for preparing a heat-storage wall, where a eutectic phase-change material and a gas-phase silicon dioxide are used; the gas-phase silicon dioxide is hydrophobic and used as a porous adsorbent material; and a porous material adsorption method is used so that the eutectic phase-change material is adsorbed in pores of the gas-phase silicon dioxide and a shape-stabilized composite phase-change material is prepared. However, in practical engineering, cost of graphene and hydrophobic gas-phase silicon dioxide is high, and in a multi-layer graphene, the thermal conductivity between layers is not high, which restricts wide application of phase-change concrete materials at present.

### SUMMARY

Objects of the present disclosure are to provide a phase-change heat-storage foamed concrete and a preparation method and use thereof. The phase-change heat-storage foamed concrete provided by the present disclosure has a low thermal conductivity, a significantly-improved heat-absorbing capability, a high structural stability, and a low production cost, thus being suitable for use in a large-scale production.

In order to achieve the above objects, the present disclosure provides the following technical solutions.

The present disclosure provides a phase-change heat-storage foamed concrete, being prepared from raw materials including, in percentages by mass: 50-70% of a cement, 2-20% of a supported phase-change material, 15-35% of water, 0.1-0.5% of a water-reducing agent, 0.5-1.5% of a foam stabilizing agent, 0.5-2% of an aqueous hydrogen peroxide solution, and 0.1-0.4% of a hydrogen peroxide decomposition catalyst; where the supported phase-change material includes an acid-modified fly ash and a paraffin supported on a surface and in a pore structure of the acid-modified fly ash; and the aqueous hydrogen peroxide solution has a mass percentage concentration of 25-30%.

In some embodiments, the supported phase-change material is prepared by a process including the steps of:
mixing a fly ash and an acid solution to obtain a mixture, and subjecting the mixture to modification to obtain the acid-modified fly ash; and
mixing the acid-modified fly ash and a molten paraffin under a vacuum condition, and conducting vacuum impregnation to obtain the supported phase-change material.

In some embodiments, the acid solution is a hydrochloric acid solution, the hydrochloric acid solution has a mass percentage concentration of 11%, and a mass ratio of the fly ash and the acid solution is 1:5.

In some embodiments, the fly ash is at least one selected from the group consisting of Class I of type F fly ash and Class II of the type F fly ash.

In some embodiments, the cement is one or more selected from the group consisting of ordinary silicate cement 42.5, 42.5R and 52.5.

In some embodiments, the water-reducing agent is a polycarboxylic acid-based high-performance water-reducing agent.

In some embodiments, the hydrogen peroxide decomposition catalyst includes one or more selected from the group consisting of manganese dioxide, ferric chloride and copper oxide.

In some embodiments, the foam stabilizing agent includes one or more selected from the group consisting of calcium stearate, sodium dodecylbenzene sulfonate, sodium dodecyl sulfate, cellulose ether and polyacrylamide.

The present disclosure provides a method for preparing the phase-change heat-storage foamed concrete described in the above technical solutions, including the steps of:
mixing the cement, the supported phase-change material, the water, the water-reducing agent, the foam stabilizing agent, the aqueous hydrogen peroxide solution and the hydrogen peroxide decomposition catalyst to obtain a mixed concrete slurry;
hardening the mixed concrete slurry in a mold to obtain a molded body; and
curing the molded body to obtain the phase-change heat-storage foamed concrete.

The present disclosure provides use of the phase-change heat-storage foamed concrete described in the above technical solutions or the phase-change heat-storage foamed concrete prepared by the method described in the above technical solution as a heat-insulating building material.

The present disclosure provides a phase-change heat-storage foamed concrete, being prepared from raw materials including, in percentages by mass: 50-70% of a cement, 2-20% of a supported phase-change material, 15-35% of water, 0.1-0.5% of a water-reducing agent, 0.5-1.5% of a foam stabilizing agent, 0.5-2% of an aqueous hydrogen peroxide solution, and 0.1-0.4% of a hydrogen peroxide decomposition catalyst; where the supported phase-change material includes an acid-modified fly ash and a paraffin supported on a surface and in a pore structure of the acid-modified fly ash; and the aqueous hydrogen peroxide solution has a mass percentage concentration of 25-30%. The advantages of the present disclosure over prior art are as follows. Compared to a conventional foamed concrete, the phase-change heat-storage foamed concrete provided by the present disclosure has a reduced thermal conductivity, a significantly-improved heat-absorbing capability and a lower production cost, and thus could be used in a large amount in actual production to reduce engineering costs. Additionally, compared to other heat-storage materials, the paraffin has a low cost, environmental friendliness and good stability; a fly ash has a micropore structure and a large specific surface area, and may serve as a carrier for the paraffin used as phase-change material; and the pore structure of the acid-modified fly ash could prevent flow and leakage of a molten paraffin used as the phase-change material, thereby enabling structure of the phase-change heat-storage foamed concrete provided by the present disclosure to be stabler. Finally, the present disclosure is based on a foamed concrete, which provides a porous and lightweight structure and does not increase structural burden of buildings.

The present disclosure provides a method for preparing the phase-change heat-storage foamed concrete described in the above technical solution. The method provided by the present disclosure is easy to perform, thus being suitable for industrialized production.

### DETAILED DESCRIPTION OF THE EMBODIMENTS

The present disclosure provides a phase-change heat-storage foamed concrete, being prepared from raw materials including, in percentages by mass: 50-70% of a cement, 2-20% of a supported phase-change material, 15-35% of water, 0.1-0.5% of a water-reducing agent, 0.5-1.5% of a foam stabilizing agent, 0.5-2% of an aqueous hydrogen peroxide solution, and 0.1-0.4% of a hydrogen peroxide decomposition catalyst; where the supported phase-change material includes an acid-modified fly ash and a paraffin supported on a surface and in a pore structure of the acid-modified fly ash; and the aqueous hydrogen peroxide solution has a mass percentage concentration of 25-30%.

In the present disclosure, unless otherwise specified, all the raw materials/components for preparation are commercially-available products well-known to those skilled in the art.

In some embodiments of the present disclosure, in percentages by mass, the raw materials for preparing the phase-change heat-storage foamed concrete include 50-70%, preferably 55-65%, and specifically 54.71% of the cement. In some embodiments of the present disclosure, the cement is one or more selected from the group consisting of ordinary silicate cement 42.5, 42.5R and 52.5 (in accordance with the provisions of GB175-2007 “General Portland Cement”, the method specified in GB/T17671-1999 “Cement Mortar Strength Test Method (ISO Method)”), and specifically the ordinary silicate cement 42.5.

In some embodiments of the present disclosure, in percentages by mass, the raw materials for preparing the phase-change heat-storage foamed concrete include 2-20%, preferably 5-15%, and specifically 12.63% of the supported phase-change material. In the present disclosure, the supported phase-change material includes an acid-modified fly ash and a paraffin supported on a surface and in a pore structure of the acid-modified fly ash.

In some embodiments of the present disclosure, the supported phase-change material is prepared by a process including the steps of:
mixing a fly ash and an acid solution to obtain a mixture, and subjecting the mixture to modification to obtain the acid-modified fly ash; and
mixing the acid-modified fly ash and a molten paraffin under a vacuum condition, and conducting vacuum impregnation to obtain the supported phase-change material.

In the present disclosure, a fly ash and an acid solution are mixed to obtain a mixture, and the mixture is subjected to modification to obtain the acid-modified fly ash. In some embodiments of the present disclosure, the acid solution is hydrochloric acid solution, the hydrochloric acid solution has a mass percentage concentration of 11%. In some embodiments of the present disclosure, the fly ash is at least one selected from the group consisting of Class I of type F fly ash and Class II of the type F fly ash, specifically the Class I of the type F fly ash. The type F fly ash is fly ash collected by anthracite or bituminous coal combustion. Class I fly ash: the sieve allowance of 45 μm square hole sieve is not more than 12%, the water requirement ratio is not more than 95%, loss on ignition is not more than 5%, moisture content not more than 1%, sulphur trioxide content not more than 3%. Class II fly ash: the sieve allowance of 45 μm square hole sieve is not more than 20%, the water requirement ratio is not more than 105%, loss on ignition is not more than 8%, moisture content not more than 2%, sulphur trioxide content not more than 3%. In the present disclosure, there are no special requirements for a source of the fly ash, and a commercially-available product well known to those skilled in the art may be adopted. In some embodiments of the present disclosure, before the mixing, the fly ash is subjected to drying, the specific embodiment of the drying is oven drying, and the drying is conducted at a temperature of 105° C. In some embodiments of the present disclosure, after the completion of the drying, a mass ratio of the fly ash to the acid solution is 1:5. In some embodiments of the present disclosure, the modification is conducted in a thermostatic magnetic stirrer. In some embodiments of the present disclosure, the modification is conducted at room temperature foe 4 h. In some embodiments of the present disclosure, the modification is conducted under stirring. After the completion of the modification, a modified slurry is obtained. In some embodiments of the present disclosure, the modified slurry is subjected to solid-liquid separation, and a resulting solid product is subjected to water-washing and drying in sequence to obtain the acid-modified fly ash. In some embodiments of the present disclosure, the specific embodiment of the solid-liquid separation is suction filtration. In some embodiments of the present disclosure, the water-washing is conducted using deionized water. In some embodiments of the present disclosure, in the water-washing, the solid product is washed until neutral. In some embodiments of the present disclosure, the specific embodiment of the drying is oven drying, and the drying is conducted at a temperature of 105° C. for 2 h.

In the present disclosure, after the acid-modified fly ash is obtained, the acid-modified fly ash and a molten paraffin are mixed under a vacuum condition, a resulting mixture is subjected to vacuum impregnation to obtain a supported phase-change material. In some embodiments of the present disclosure, the vacuum impregnation is conducted in a vacuum vessel, and the molten paraffin is obtained by heating the solid paraffin in a thermostatic water bath. In some embodiments of the present disclosure, the vacuum impregnation is conducted at a vacuum degree of 0.095 MPa for 2 h, and the vacuum impregnation is conducted under stirring.

In some embodiments of the present disclosure, in percentages by mass, the raw materials for preparing the phase-change heat-storage foamed concrete include 15-35%, preferably 16-36%, and specifically 30.64% of the water.

In some embodiments of the present disclosure, in percentages by mass, the raw materials for preparing the phase-change heat-storage foamed concrete include 0.1-0.5%, preferably 0.2-0.4%, and specifically 0.25% of the water-reducing agent. In some embodiments of the present disclosure, the water-reducing agent is a polycarboxylic acid-based high-performance water-reducing agent. In a specific embodiment of the present disclosure, the polycarboxylic acid-based high performance water-reducing agent is purchased from Shanxi Feike New Materials Technology Co., Ltd., China, with product type being FK-A (standard type).

In some embodiments of the present disclosure, in percentages by mass, the raw materials for preparing the phase-change heat-storage foamed concrete include 0.5-1.5%, preferably 0.5-1%, and specifically 0.67% of the foam stabilizing agent. In some embodiments of the present disclosure, the foam stabilizing agent includes one or more selected from the group consisting of calcium stearate, sodium dodecylbenzene sulfonate, sodium dodecyl sulfate, cellulose ether and polyacrylamide, and specifically the calcium stearate.

In some embodiments of the present disclosure, in percentages by mass, the raw materials for preparing the phase-change heat-storage foamed concrete include 0.5-2%, preferably 0.9-1.5%, and specifically 0.93% of the aqueous hydrogen peroxide solution. In some embodiments of the present disclosure, the aqueous hydrogen peroxide solution has a mass percentage concentration of 25-30%, and preferably 30%. In the present disclosure, the aqueous hydrogen peroxide solution is used as a pore-forming agent.

In some embodiments of the present disclosure, in percentages by mass, the raw materials for preparing the phase-change heat-storage foamed concrete include 0.1-0.4%, and preferably 0.17% of the hydrogen peroxide decomposition catalyst. In some embodiments of the present disclosure, the hydrogen peroxide decomposition catalyst includes one or more selected from the group consisting of manganese dioxide, ferric chloride and copper oxide, and specifically the manganese dioxide.

The present disclosure provides a method for preparing the phase-change heat-storage foamed concrete described in the above technical solution, including the steps of:
mixing the cement, the supported phase-change material, the water, the water-reducing agent, the foam stabilizing agent, the aqueous hydrogen peroxide solution and the hydrogen peroxide decomposition catalyst to obtain a mixed concrete slurry;
hardening the mixed concrete slurry in a mold to obtain a molded body; and
curing the molded body to obtain the phase-change heat-storage foamed concrete.

In the present disclosure, the cement, the supported phase-change material, the water, the water-reducing agent, the foam stabilizing agent, the aqueous hydrogen peroxide solution and the hydrogen peroxide decomposition catalyst are mixed to obtain a mixed concrete slurry. In some embodiments of the present disclosure, the mixing includes the steps of: subjecting the cement, the supported phase-change material, the water-reducing agent and the hydrogen peroxide decomposition catalyst to primary mixing to obtain a dry mixture; subjecting the dry mixture, the water and the foam stabilizing agent to secondary mixing to obtain a cement mortar; and subjecting the cement mortar and the aqueous hydrogen peroxide solution to tertiary mixing to obtain the mixed concrete slurry. In some embodiments of the present disclosure, the primary mixing is conducted at room temperature. In some embodiments of the present disclosure, the primary mixing is conducted under stirring, and the primary mixing is conducted at a rotation speed of 30 r/min for 1 min. In some embodiments of the present disclosure, the secondary mixing is conducted at room temperature. In some embodiments of the present disclosure, the secondary mixing is conducted under stirring, and the secondary mixing is conducted at a rotation speed of 30 r/min for 1 min. In some embodiments of the present disclosure, the tertiary mixing is conducted at room temperature. In some embodiments of the present disclosure, the tertiary mixing is conducted under stirring, and the tertiary mixing is conducted at a rotation speed of stirring is 35 r/min for 0.5 min.

In the present disclosure, after the mixed concrete slurry is obtained, the mixed concrete slurry is hardened in a mold to obtain a molded body. In some embodiments of the present disclosure, the hardening and molding is conducted at room temperature.

In the present disclosure, after the molded body is obtained, the molded body is cured to obtain the phase-change heat-storage foamed concrete. In some embodiments of the present disclosure, the curing is conducted at a temperature of 20±2° C. The curing is conducted for 28 days. The curing is conducted at a relative humidity of 95% or higher.

The present disclosure provides use of the phase-change heat-storage foamed concrete described in the above technical solutions or the phase-change heat-storage foamed concrete prepared by the method described in the above technical solution as a heat-insulating building material.

In some embodiments of the present disclosure, specifically, the heat-insulating building material is a heat-insulating foamed concrete brick or a heat-insulating foamed concrete slab. The heat-insulating foamed concrete brick or heat-insulating foamed concrete slab could form a heat-insulating building wall to greatly reduce a fluctuation of indoor temperature of buildings.

The phase-change heat-storage foamed concrete provided by the present disclosure has a higher compressive strength and a lower thermal conductivity, and could greatly improve indoor temperature conditions of the buildings and greatly reduce the fluctuation of the indoor temperature when used as the heat-insulating building material. Thereby, the frequency of use of indoor thermostats such as air-conditioner is reduced, and energy consumption is lowered, which are conducive to the improvement of energy efficiency of the buildings.

To further describe the present disclosure, the technical solutions provided by the present disclosure will be described in detail below in conjunction with examples, but these examples could not be understood as limiting the scope of the present disclosure.

### Example 1

This example provided a phase-change heat-storage foamed concrete, which was prepared from raw materials consisting of, in percentages by mass: 54.71% of a cement, 12.63% of a supported phase-change material, 30.64% of water, 0.25% of a water-reducing agent, 0.67% of a foam stabilizing agent, 0.93% of an aqueous hydrogen peroxide solution and 0.17% of a hydrogen peroxide decomposition catalyst.

Where, the cement was a 42.5 grade ordinary silicate cement; the supported phase-change material was an acid-modified fly ash and a paraffin supported on a surface and in a pore structure of the acid-modified fly ash; a fly ash raw material used in preparation of the supported phase-change material was a commercially-available Class I of type F fly ash; the water-reducing agent was a polycarboxylic acid-based high-performance water-reducing agent purchased from Shanxi Feike New Materials Technology Co., Ltd., China, with product type being FK-A (standard type); the foam stabilizing agent was calcium stearate; the aqueous hydrogen peroxide solution had a mass percentage concentration of 30%; and the hydrogen peroxide decomposition catalyst was manganese dioxide.

Specifically, the method for preparing the phase-change heat-storage foamed concrete provided by this example was performed as follows.
S1: a fly ash was subjected to oven-drying (at a temperature of 105° C.) and subjected to cooling, and then was mixed with a hydrochloric acid solution (with a mass percentage concentration of 1%) in a mass ratio of 1:5, and a resulting mixture was subjected to modification under stirring at room temperature for 2 h. After the completion of the modification, a resulting modified slurry was subjected to suction filtration, and a resulting solid product was subjected to water-washing using deionized water until neutral, and then subjected to oven-drying at 105° C. to obtain an acid-modified fly ash. The paraffin was heated to a molten state in a thermostatic water bath, and transferred to a vacuum vessel; and then the acid-modified fly ash was added and stirred. A resulting mixture was subjected to vacuum impregnation for 2 h to obtain the supported phase-change material.
S2: in percentages by mass, the 42.5 grade ordinary silicate cement, the supported phase-change material, the polycarboxylic acid-based high-performance water-reducing agent and the manganese dioxide were added to a stirring apparatus in sequence, and then the stirring apparatus was started with a rotation speed of 30 r/min, and stirring was performed for 1 min to obtain a dry mixture.
S3: the water and the calcium stearate was added to the dry mixture of step S2 to obtain a mixture, and with the rotation speed kept at 30 r/min, stirring was performed for 1 min, so that the mixture fully dispersed and the formation of clots significantly decreased; and then an aqueous solution of 30 mass % hydrogen peroxide was added thereto, the rotation speed was increased to 35 r/min, and stirring was performed for 0.5 min to obtain a foamed concrete mortar.
S4: the foamed concrete mortar in step S3 was poured into where it is desired to be used, or poured into a mold to form a foamed concrete product including a foamed concrete brick and a foamed concrete slab, and curing was performed for 28 days (at a temperature of 20±2° C. and a relative humidity≥95%). After the completion of curing, the foamed concrete product could be used.

The performance of a cured phase-change heat-storage foamed concrete building block in this example was tested, and the results are shown in table 1. Where, the compressive strength was tested according to JG/T 266-2011 “foamed concrete”.

TABLE 1
Performance test results of the phase-change heat-
storage foamed concrete prepared in example 1

| | | Latent heat | | |
|---|---|---|---|---|
| Compressive | Thermal | of | | Water |
| strength | conductivity | phase-change | Porosity | absorption |
| (MPa) | (W/(m · K)) | J/g | (%) | (%) |
| 4.0 | 0.142 | 13.37 | 63 | 23 |

As can be seen from table 1, the phase-change heat-storage foamed concrete prepared by the present disclosure has a reduced thermal conductivity, a high heat-absorbing capability and a higher compressive strength, thus having both physical performance and thermal performance.

### Comparative Example 1

This comparative example provided a phase-change heat-storage foamed concrete, which was prepared from raw materials consisting of, in percentages by mass: 52.46% of a cement, 12.11% of a supported phase-change material, 33.09% of water, 0.24% of a water-reducing agent, 0.65% of a foam stabilizing agent, 1.29% of an aqueous hydrogen peroxide solution and 0.16% of a hydrogen peroxide decomposition catalyst.

Where, the cement was a 42.5 grade ordinary silicate cement; the supported phase-change material was an acid-modified fly ash and a paraffin supported on a surface and in a pore structure of the acid-modified fly ash; a fly ash raw material used in preparation of the supported phase-change material was a commercially-available Class I of type F fly ash; the water-reducing agent was a polycarboxylic acid-based high-performance water-reducing agent purchased from Shanxi Feike New Materials Technology Co., Ltd., China, with product type being FK-A (standard type); the foam stabilizing agent is calcium stearate; the aqueous hydrogen peroxide solution had a mass percentage concentration of 30%; and the hydrogen peroxide decomposition catalyst was manganese dioxide.

Specifically, the method for preparing the phase-change heat-storage foamed concrete provided by this comparative example was performed as follows.
S1: a fly ash was subjected to oven-drying (at a temperature of 105° C.) and subjected to cooling, and then was mixed with a hydrochloric acid solution (a mass percentage concentration of being 11%) in a mass ratio of 1:5, and a resulting mixture was subjected to modification under stirring at room temperature for 2 h. After the completion of the modification, a resulting modified slurry was subjected to suction filtration, and a resulting solid product was subjected to water-washing using deionized water until neutral, and then subjected to oven-drying at 105° C. to obtain an acid-modified fly ash. The paraffin was heated to a molten state in a thermostatic water bath, and transferred to a vacuum vessel; and then the acid-modified fly ash was added and stirred. A resulting mixture is subjected to vacuum impregnation for 2 h to obtain the supported phase-change material.
S2: in percentages by mass, the 42.5 grade ordinary silicate cement, the supported phase-change material, the polycarboxylic acid-based high-performance water-reducing agent and the manganese dioxide were added into a stirring apparatus in sequence, and then the stirring apparatus was started with a rotation speed of 30 r/min, and stirring was performed for 1 min to obtain a dry mixture.
S3: the water and the calcium stearate was added to the dry mixture of step S2 to obtain a mixture, and with the rotation speed kept at 30 r/min, stirring was performed for 1 min, so that the mixture fully disperse and the formation of clots significantly decreased; and then an aqueous solution of 30 mass % hydrogen peroxide was added thereto, the rotation speed was increased to 35 r/min, and stirring was performed for 0.5 min to obtain a foamed concrete mortar.
S4: the foamed concrete mortar in step S3 was poured into where it is desired to be used, or poured into a mold to form a foamed concrete product including a foamed concrete brick and a foamed concrete slab, and curing was performed for 28 days (at a temperature of 20±2° C. and a relative humidity≥95%). After the completion of curing, the foamed concrete product could be used.

In this comparative example, a ratio of water to ash was increased (the ratio of water to ash was 0.56 in example 1 and 0.63 in comparative example 1), and a addition amount of the aqueous hydrogen peroxide solution was also increased. As a result, the foamed concrete product has a larger porosity and an extremely low compressive strength (<0.1 MPa), thus being inapplicable to production and living. This is because when the ratio of water to ash is relatively large, there will be less cement particles in a concrete mixture, and distances between particles is relatively large. As a result, a colloid produced via hydration is insufficient for filling voids between particles, which reduces the strength of concrete and affects the compressive strength of foamed concrete. On the other hand, when excessive chemical foaming agent is added to the concrete mortar, a number of bubbles will increase, and small closed bubbles will gather to form connected through-bubbles, which will increase the porosity of a test block. Additionally, gathered large bubbles will reduce the compressive strength of the foamed concrete.

As can be seen from the example above, the present disclosure provides a phase-change heat-storage foamed concrete and a preparation method thereof. The phase-change heat-storage foamed concrete provided by the present disclosure is prepared from raw materials including: a cement, a supported phase-change material, a foam stabilizing agent, a water-reducing agent, an aqueous hydrogen peroxide solution and water. The specific method includes the steps of: subjecting fly ash to modification with a hydrochloric acid solution to obtain an acid-modified fly ash; supporting a phase-change material in pores of the acid-modified fly ash by using vacuum adsorption method to obtain a supported phase-change material; and adding the supported phase-change material to a foamed concrete slurry, and then stirring, pouring, molding and curing to obtain the phase-change heat-storage foamed concrete. The phase-change heat-storage foamed concrete of the present disclosure has a higher compressive strength and a lower thermal conductivity.

Although the present disclosure is described in detail in conjunction with the foregoing examples, they are only a part of, not all of, the embodiments of the present disclosure. Other embodiments can be obtained based on these embodiments without creative efforts, and all of these embodiments shall fall within the scope of the present disclosure.

What is claimed is:

1. A phase-change heat-storage foamed concrete, being prepared from raw materials comprising, in percentages by mass:
50-70% of a cement;
2-20% of a supported phase-change material, the supported phase-change material comprising an acid-modified fly ash and a paraffin supported on a surface and in a pore structure of the acid-modified fly ash;
15-35% of water;
0.1-0.5% of a water-reducing agent;
0.5-1.5% of a foam stabilizing agent;
0.5-2% of an aqueous hydrogen peroxide solution having a mass percentage concentration of 25-30%; and
0.1-0.4% of a hydrogen peroxide decomposition catalyst.

2. The phase-change heat-storage foamed concrete of claim 1, wherein the supported phase-change material is prepared by a process comprising:
mixing a fly ash and an acid solution to obtain a mixture, and subjecting the mixture to modification to obtain the acid-modified fly ash; and
mixing the acid-modified fly ash and a molten paraffin under a vacuum condition and conducting vacuum impregnation to obtain the supported phase-change material.

3. The phase-change heat-storage foamed concrete of claim 2, wherein the acid solution is a hydrochloric acid solution having a mass percentage concentration of 11%, and a mass ratio of the fly ash and the acid solution is 1:5.

4. The phase-change heat-storage foamed concrete of claim 2, wherein the fly ash is at least one selected from the group consisting of Class I of type F fly ash and Class II of the type F fly ash.

5. The phase-change heat-storage foamed concrete of claim 1, wherein the cement is at least one selected from the group consisting of ordinary silicate cement 42.5, 42.5R and 52.5.

6. The phase-change heat-storage foamed concrete of claim 1, wherein the water-reducing agent is a polycarboxylic acid-based water-reducing agent.

7. The phase-change heat-storage foamed concrete of claim 1, wherein the hydrogen peroxide decomposition catalyst comprises at least one selected from the group consisting of manganese dioxide, ferric chloride and copper oxide.

8. The phase-change heat-storage foamed concrete of claim 1, wherein the foam stabilizing agent comprises at least one selected from the group consisting of calcium stearate, sodium dodecylbenzene sulfonate, sodium dodecyl sulfate, cellulose ether and polyacrylamide.

9. A method for preparing the phase-change heat-storage foamed concrete of claim 1, comprising:
mixing the cement, the supported phase-change material, the water, the water-reducing agent, the foam stabilizing agent, the aqueous hydrogen peroxide solution and the hydrogen peroxide decomposition catalyst to obtain a mixed concrete slurry;
hardening the mixed concrete slurry in a mold to obtain a molded body; and
curing the molded body to obtain the phase-change heat-storage foamed concrete.

10. A method of using the phase-change heat-storage foamed concrete of claim 1, comprising using the phase-change heat-storage foamed concrete as a heat-insulating building material.

11. The phase-change heat-storage foamed concrete of claim 3, wherein the fly ash is at least one selected from the group consisting of Class I of type F fly ash and Class II of the type F fly ash.

12. The method of claim 9, wherein the supported phase-change material is prepared by a process comprising:
mixing a fly ash and an acid solution to obtain a mixture, and subjecting the mixture to modification to obtain the acid-modified fly ash; and
mixing the acid-modified fly ash and a molten paraffin under a vacuum condition, and conducting vacuum impregnation to obtain the supported phase-change material.

13. The method of claim 9, wherein the acid solution is a hydrochloric acid solution having a mass percentage concentration of 11%, and a mass ratio of the fly ash and the acid solution is 1:5.

14. The method of claim 9, wherein the fly ash is at least one selected from the group consisting of Class I of type F fly ash and Class II of the type F fly ash.

15. The method of claim 9, wherein the cement is at least one selected from the group consisting of ordinary silicate cement 42.5, 42.5R and 52.5.

16. The method of claim 9, wherein the water-reducing agent is a polycarboxylic acid-based high-performance water-reducing agent.

17. The method of claim 9, wherein the hydrogen peroxide decomposition catalyst comprises at least one selected from the group consisting of manganese dioxide, ferric chloride and copper oxide.

18. The method of claim 9, wherein the foam stabilizing agent comprises at least one selected from the group consisting of calcium stearate, sodium dodecylbenzene sulfonate, sodium dodecyl sulfate, cellulose ether and polyacrylamide.

19. The method of claim 10, wherein the supported phase-change material is prepared by a process comprising:
mixing a fly ash and an acid solution to obtain a mixture, and subjecting the mixture to modification to obtain the acid-modified fly ash; and
mixing the acid-modified fly ash and a molten paraffin under a vacuum condition, and conducting vacuum impregnation to obtain the supported phase-change material.

20. The method of claim 10, wherein the acid solution is a hydrochloric acid solution having a mass percentage concentration of 11%, and a mass ratio of the fly ash and the acid solution is 1:5.
